(19) United States
(12) Patent Application Publication
(10) Pub. No.: US 2026/0257180 A1
(43) Pub. Date: Sep. 3, 2026

(54) BLENDING PARTICULATE MATERIAL

(71) Applicant: John Andersen, Hope Island (AU)

(72) Inventor: John Andersen, Hope Island (AU)

(21) Appl. No.: 19/163,204

(22) PCT Filed: Mar. 8, 2024
(86) PCT No.: PCT/AU2024/050207

§ 371 Date: Sep. 8, 2025

(30) Foreign Application Priority Data
Mar. 10, 2023 (AU) 2023201523

(51) Int. Cl. B01F 23/60; B01F 33/502; B01F 35/21; B01F 35/221; B01F 35/43; B01F 35/71

(52) U.S. Cl. CPC B01F 23/69; B01F 33/5021; B01F 35/2117; B01F 35/22141; B01F 35/43; B01F 35/71705; B01F 35/71731; B01F 35/718051

(57) ABSTRACT

A mobile blending apparatus that includes a chassis. A ground-engaging drive mechanism is arranged on the chassis and is configured for driving the chassis along the ground. A support structure is mounted on the chassis. Hopper assemblies are mounted on respective substructures. A feed zone is defined between the hopper assemblies. Each hopper assembly includes two receptacles configured to receive materials to be blended. Four conveyor assemblies are mounted in respective receptacles and extend out of feed openings into the feed zone. A controllable drive mechanism controls a speed of conveyance of the materials from the receptacles. A weighing mechanism is engaged with each conveyor assembly to measure a feed rate of material. A programmable control mechanism controls a speed of each conveyor assembly based on measurements received from the continuous weighing mechanisms to achieve a desired mixture of materials from the receptacles.

### FIELD OF THE INVENTION

This invention relates to a mobile blending apparatus for particulate material. The invention also relates to a method of blending particulate material.

### BACKGROUND OF THE INVENTION

There is a growing need for materials handling operations to provide custom blends of particulate material that contain ground or milled recyclable materials. This has, to some degree, resulted from regulatory requirements that require recyclable products to be used in virgin raw material to reduce land fill and reduce the requirement of virgin material for the construction and various other industries. The standards and requirements that have been set require the percentage of each product to be accurate and are tested to ensure that percentages are correct. This growing need is also driven by an increase in consumer awareness of environmental concerns associated with using raw materials.

Currently available apparatuses for providing such blends include one or more receptacles into which the separate materials that are to be blended are fed. A single conveyor assembly is operatively engaged with each receptacle to feed the materials from the receptacles into an area in which the materials are blended or mixed. Such apparatuses have accuracy limitations. For example, such apparatuses currently include gate assemblies that are operable to physically block a portion of the material being fed from the respective receptacles. This is effectively a form of volumetric control. However, given the disparate densities of the various waste materials, such volumetric control cannot provide an accurate proportion, by mass, of the various recyclable materials.

European patent publication number EP0046667 describes an apparatus for blending a plurality of batches of a dry material, characterized in that such apparatus comprises mixing means for commingling a plurality of batches of dry material and including a plurality of material-receiving receptacles and a blender. The receptacles are mounted for movement between loading and unloading stations and each receptacle is adapted to receive measured quantities of a dry material from several batches of dry material; and the blender being rotatably mounted for mixing dry material received from the receptacles.

International application number PCT/GB2004/005378 describes an apparatus and method for accurately metering and conveying a dry powder or granular material to a blender in a substantially closed system. The apparatus includes a storage tank adapted to hold the dry powder or granular material, a hopper inside the storage tank, and a conveyor at least partially disposed inside of the storage tank. The conveyor delivers the dry powder to the hopper. The apparatus includes a metering feeder adapted to deliver the dry powder or granular material at a substantially uniform density from the hopper to a blender located outside of the storage tank. The apparatus is a substantially closed system.

United States patent publication number US 2017/0240350A1 describes a proppant discharge system that has a container with an outlet formed at the bottom of the container. A gate is slidably affixed at the outlet to be movable between a first position covering the outlet to a second position opening the outlet. The system has a support structure having an actuator thereon. The container is removably positioned on the top surface of the support structure. The actuator is engageable with the gate to move the gate from the first position to the second position. A conveyor underlies the container to receive proppant as discharge from the container through the outlet. The container is a ten-foot ISO container.

United States patent publication number US 2019/0144216A1 describes a system for conveying non-dry frac proppant. The system includes at least one hopper having at least one moisture sensor, a slide gate fluidly connected to the at least one hopper, a conveyor assembly having at least one conveyor belt configured to convey the non-dry frac proppant from the at least one hopper to a blender, and a control device configured to regulate the discharge rate of the non-dry frac proppant and a load rate of the non-dry frac proppant.

United States patent publication number US 2013/0062164A1 describes a material conveyor system for a road paver and feeder. The system comprises first and second hopper halves, with a main conveyor device running between the first and second conveyor halves. Conveying screws are arranged in the conveyor halves and define a transverse conveyor flow. The conveying screws can convey material from each of the hopper halves onto the main conveyor device. The conveying screws can be independently operated to achieve homogenisation of the mixing temperature of the paving material.

United States patent publication number US 2020/0240237A1 describes a proppant container that facilitates the transportation of wet sand for use in a hydraulic fracturing operation. A metering conveyor is positioned between a blender tub and a proppant motive mechanism such as a conveyor or wash system that receives discharge direct from the proppant containers of the type normally used to transport sand in support of a hydraulic fracturing operation. The metering conveyor is fitted with sensors and/or a knife-edge gate that may be used to facilitate flow control operations.

United States patent application US 2021/0024291A1 describes a proppant metering and loading apparatus for a hydraulic fracturing blender unit. A continuous loop conveyor belt receives proppant from a source location on the blender, such as a hopper, and delivers the proppant to a blender device of the blender. A measurement device (for example a weigh scale) measures and provides an indication of an amount (for example weight, volume and/or density) of the proppant delivered to the blender device by the conveyor belt.

U.S. Pat. No. 3,645,505 describes a colour blender for a plastic-processing machine of the type which is adapted to be mounted on the machine. The colour blender comprises a constant rate screw type conveyor for the primary material and a variable rate screw type conveyor for the colour additive, both of which have an outlet in a combining chamber. The materials are co-mingled in the combining chamber and a mixing conveyor blends the components and delivers them to a receiver such as a holding hopper on the processing machine. The blender can be provided with a pair of variable rate supply units together with the constant rate conveyor so that an additional component such as re-grind material may be combined with the primary and colour additive materials.

United States patent publication number US 2020/0406502A1 describes a mobile aggregate hopper for a volumetric and gravimetric mixer having arcuate longitudinal walls for holding and isolating aggregate. The mobile aggregate hopper has a base integral with the arcuate longitudinal walls with an aggregate transfer conveyor and means for attachment to a trailer chassis having wheels.

Chinese patent publication number CN106395320 describes a double roller type quantitative material mixer. Double rollers are transversely arranged left and right, wherein the two ends and the middle part of each roller are equipped with ring-shaped baffle plates. A gap is formed between the rollers for allowing the raw materials and the fuels to pass through. A conveyor belt is positioned below the rollers, and a feed hopper is arranged above the rollers. The hopper is divided into two parts with different capacities through a partition plate, wherein the large-capacity part is a raw material channel, and the small-capacity part is a fuel channel. One roller rotates leftwards, and one roller rotates rightwards for pulling the raw materials and the fuels from top to bottom, so that the raw materials and the fuels which continuously drop onto the conveyor belt are fed to a next process and enter a stirrer for being stirred.

Chinese patent publication number CN304762934 describes a thermal power plant fire coal blending conveying method. According to the method, two raw coal conveying lines are used, each raw coal conveying line comprises a coal yard coal pile taking machine, a first-stage belt conveyor, a second-stage coal hopper, a second-stage belt conveyor, a coal crusher, a third-stage belt conveyor, a fourth-stage coal hopper and a fourth-stage belt conveyor. Telescopic belt conveyors are arranged at the rear ends of the first-stage belt conveyors of the two raw coal conveying lines correspondingly. Coal flow out of the rear end of each of the telescopic belt conveyors is divided into two parts to fall through inclination angles of a corresponding left side flow dividing baffle and a corresponding right side flow dividing baffle of a corresponding flow dividing coal baffle device and is divided into coal flow falling towards the rear portion and coal flow falling towards the front portion to fall into the second-stage coal hoppers of the two raw coal conveying lines correspondingly. Two different types of coal are distributed to the two-stage belt conveyors of the two raw coal conveying lines correspondingly, the two different types of coal are further evenly mixed in the subsequent conveying process.

Korean patent publication number KR1020120025775 describes a portable batcher plant that comprises an aggregate hopper, an aggregate meter, a sand meter, a belt conveyor, wheels, a mixer, a water tank, and a compressor. The aggregate hopper is divided into sand and gravel hoppers. The aggregate meter is installed in the bottom end of the aggregate hopper and measures aggregate. The sand meter measures sand. The belt conveyor is installed in the bottom end of the aggregate meter and the sand meter. The wheels are installed in the bottom end of the belt conveyor. The mixer produces ready-mixed concrete by mixing supplied materials. The water tank and the compressor are inclined so that the mixer can be horizontally installed in a construction site.

The systems and apparatuses described above are not suitable for accurate mixing of more than two constituents in a compact environment, such as that which would be required for a mobile apparatus.

### SUMMARY OF THE INVENTION

According to a first aspect of the invention, there is provided a mobile blending apparatus, which comprises:
a chassis;
a ground-engaging drive mechanism that is arranged on the chassis and is configured for driving the chassis along the ground;
a support structure mounted on the chassis, the support structure including two opposed substructures;
two hopper assemblies, each hopper assembly mounted on a respective substructure, the substructures being configured so that a feed zone is defined between the hopper assemblies, each hopper assembly including:
   two receptacles, each receptacle configured to receive a material to be blended with the material in the other receptacle; and
   two feed openings in communication with respective storage volumes defined by the receptacles;
four conveyor assemblies mounted in respective receptacles and extending out of the respective feed openings to a predetermined extent and into the feed zone, each conveyor assembly including a controllable drive mechanism so that a speed of conveyance of the respective materials from the receptacles can be controlled with a suitable controller;
a continuous weighing mechanism operatively engaged with each conveyor assembly in the feed zone to measure a feed rate of material from respective receptacles; and
a programmable control mechanism to control a speed of each conveyor assembly based on measurements received from the continuous weighing mechanisms to achieve a desired mixture of materials from the receptacles.

The apparatus may include a discharge mechanism for receiving the mixture and discharging the mixture at a desired location.

Each substructure may include a rectangular frame with an inner end of the frame supported on the chassis, and two legs that are arranged on an outer end of the frame to support the frame above the substrate. The legs may be adjustable in length to suit a terrain.

Each hopper assembly may include a hopper mounted on the rectangular frame, the hopper having opposed side walls, a front wall terminating the feed zone, an opposed rear wall, and a dividing wall extending between the front and rear walls and dividing the hopper into the two receptacles.

At least part of the dividing wall may be removable to provide the hopper with a single receptacle. The dividing wall may nest with the front and rear walls in an operative position forming the two receptacles. This avoids cross-contamination of the materials in the respective receptacles and facilitates positioning on the dividing wall.

Each of the front wall, the rear wall, the side walls, and the dividing wall may include inwardly and downwardly sloping sub-walls that together define a rectangular floor opening, the conveyor assembly being configured so that the rectangular floor opening is closed by the conveyor assembly such that material in the receptacles is guided onto the respective conveyor assemblies.

Each conveyer assembly may include a conveyor belt, so that the conveyor belts define floors of the respective receptacles.

Each conveyor assembly may include a belt carrier and rollers arranged on the belt carrier and engaged with the conveyor belt to facilitate the rotation of the conveyor belt about the belt carrier.

The mobile blending apparatus may include a conveyor support structure, the belt carrier being mounted on the conveyor support structure that extends upwardly from rear wall and out through the feed opening.

Each controllable drive mechanism may be mounted on a respective conveyor support structure and may be operatively engaged with the conveyor belt so that a speed of the conveyor belts can be controlled independently.

The dividing wall may include a substructure, the sub-walls of the dividing wall being part of the substructure, the sub-walls converging at their respective upper edges. The dividing wall may further include a dividing wall assembly that is removably arranged on the substructure such that the dividing wall assembly partitions the hopper to form the two receptacles and can be removed to form the single receptacle.

The front and rear locating formations may be arranged on the front and rear walls, respectively, of each hopper, the locating formations being configured so that the dividing wall assembly can be lowered into nesting engagement with the front and rear walls to form the two receptacles of each hopper.

Each continuous weighing mechanism may be in the form of a belt weighing mechanism that is operatively engaged with the conveyor belt for dynamically weighing the material being conveyed by the conveyor belt.

The control mechanism may include a controller that is operatively connected to the continuous weighing mechanisms and the drive mechanisms to adjust the speed of the conveyance of the respective materials from the receptacles to maintain or achieve a desired mixture of the materials.

A flow control gate mechanism may be mounted on each receptacle at or near the feed opening, and may be operable to control, to some extent, a volumetric feed rate of material carried by the conveyor assembly into the feed zone.

According to a second aspect of the invention, there is provided a method of blending material with the mobile blending apparatus as claimed in any one of the preceding claims, the method comprising the steps of:
charging the respective receptacles with materials to be blended;
driving the respective conveyor assemblies to feed material from the receptacles to the discharge mechanism; and
controlling the speed of each conveyor assembly with the control mechanism to achieve the desired mixture of materials from the receptacles.

According to a third aspect of the invention, there is provided a mobile blending system which comprises:
a chassis;
a ground-engaging drive mechanism that is arranged on the chassis and is configured to drive the chassis along the ground;
a support structure mounted on the chassis;
a hopper assembly that is mounted on the support structure, the hopper assembly including:
   two receptacles, each receptacle configured to receive a material that is to be blended with the material in the other receptacle; and
   two feed openings in communication with respective storage volumes defined by the receptacles;
two conveyor assemblies mounted in respective receptacles and extending out of the respective feed openings to a predetermined extent and into a feed zone, each conveyor assembly including a controllable drive mechanism so that a speed of conveyance of the respective materials from the receptacles can be controlled with a suitable controller;
a continuous weighing mechanism operatively engaged with each conveyor assembly to measure a feed rate of material from respective receptacles; and
a mixing system mounted on the support structure, the mixing system comprising:
   a conveyor assembly that is mounted on the support structure and extends from the support structure;
   at least one vessel mounted on the support structure, above the conveyer assembly of the mixing system; and
   a valve assembly interposed between the, or each respective vessel and the conveyor assembly to control the supply of material from the, or each vessel to the conveyor assembly of the mixing system, the, or each valve assembly being operatively connected to the programmable control mechanism for controlling operation of the, or each valve assembly.

The blending system may include a mixing apparatus mounted on a discharge end of the conveyor assembly for mixing product from the hopper assemblies and the, or each vessel.

The mobile blending system may include a material discharge mechanism that interconnects the conveyor assemblies to facilitate the feed of material from the hopper assembly into the conveyor assembly of the blending and mixing system. The discharge mechanism may be in the form of a feed chute interconnecting the conveyor assemblies that extend from the hopper assembly to the conveyer assembly of the mixing system.

The mixing apparatus may be in the form of a pugmill or any other machine-driven mixer depending on requirements. Thus, the mixing apparatus may be in the form of a pugmill system. The pugmill system may be a conventional pugmill system.

According to a fourth aspect of the invention, there is provided a method of blending material with the mobile blending system described above, the method comprising the steps of:
charging the respective receptacles with materials to be blended;
charging the, or each vessel with material to be blended with the material in the receptacles;
driving the conveyor assemblies that extend from the receptacles to feed material from the receptacles to the conveyor assembly of the mixing system; and
driving the conveyor assembly of the mixing system to convey material from the receptacles mixed with material from the, or each vessel; and
controlling the speed of each conveyor assembly and operation of the, or each valve assembly to achieve a desired mixture of materials from the mixing system.

The method may include the step of driving the conveyor assembly of the mixing system to feed the mixed material to a mixing apparatus;

According to a fifth aspect of the invention, there is provided a mobile blending apparatus which comprises:
a chassis;
a ground-engaging drive mechanism that is arranged on the chassis and is configured to drive the chassis along the ground;
a support structure mounted on the chassis;
a hopper assembly that is mounted on the support structure, the hopper assembly including:
   two receptacles, each receptacle configured to receive one of two materials to be blended with the other material; and
   two feed openings in communication with respective storage volumes defined by the receptacles;
two conveyor assemblies mounted in respective receptacles and extending out of the respective feed openings to a predetermined extent and into the feed zone, each conveyor assembly including a controllable drive mechanism so that a speed of conveyance of the respective materials from the receptacles can be controlled with a suitable controller; and
a continuous weighing mechanism operatively engaged with each conveyor assembly to measure a feed rate of material from respective receptacles;

### BRIEF DESCRIPTION OF THE DRAWINGS

FIG. 1 shows a three-dimensional view, from above, of an embodiment of a mobile blending apparatus, in accordance with the invention.

FIG. 2 shows a top plan view of the blending apparatus of FIG. 1.

FIG. 3 shows a side view of the blending apparatus of FIG. 1.

FIG. 4 shows part of the apparatus of FIG. 1, without a chassis and ground-engaging drive mechanism, forming an embodiment of a further blending apparatus, in accordance with the invention.

FIG. 5 shows a detailed view of two conveyor assemblies of the apparatus of FIG. 1 or 4 extending into a feed zone.

FIG. 6 shows a side view of the part shown in FIG. 4.

FIG. 7 shows a section view taken through A-A in FIG. 6.

FIG. 8 shows a top plan view of the apparatus shown in FIG. 4.

FIG. 9 shows a section view taken through B-B in FIG. 8.

FIG. 10 shows a section view taken through C-C in FIG. 8.

FIG. 11 shows a control layout of the apparatus of FIG. 1.

FIG. 12 shows a flowchart illustrating a method of blending using the apparatus of FIG. 1.

FIG. 13 shows a schematic, three-dimensional view of an embodiment of a system, in accordance with the invention, for blending materials.

FIG. 14 shows a side view of the system of FIG. 13.

FIG. 15 shows a control layout of the system of FIG. 13.

FIG. 16 shows a flowchart illustrating a method of generating product from the system of FIG. 13.

FIG. 17 shows a schematic, three-dimensional view of an embodiment of a system, in accordance with the invention, for blending materials.

FIG. 18 shows two feed hoppers of the system of FIG. 17.

FIG. 19 shows the apparatus of FIG. 4 and the feed hoppers of FIG. 18 connected to a conveyor assembly of the system of FIG. 17.

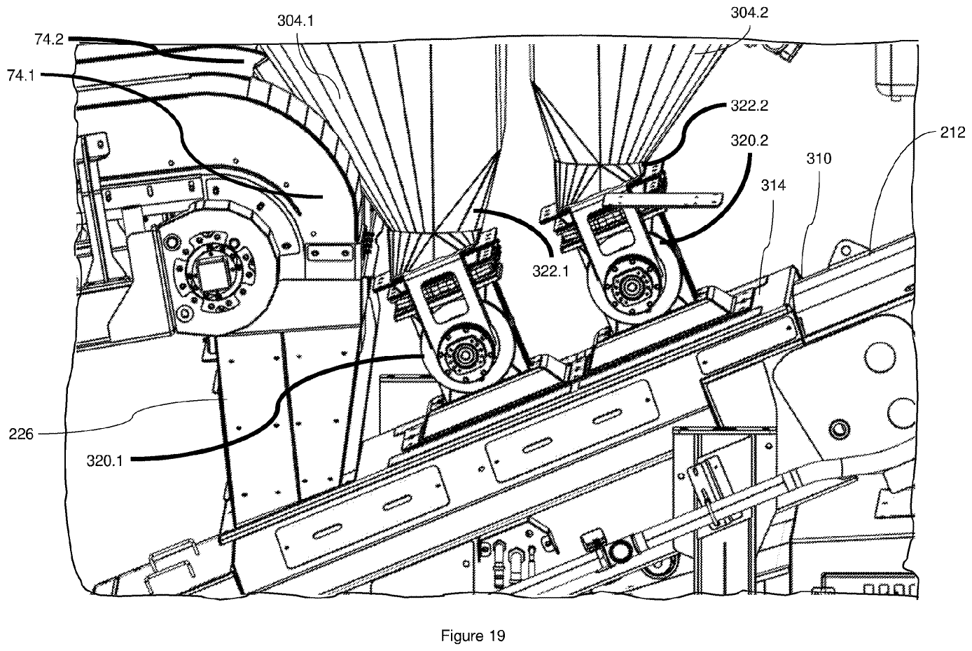

FIG. 20 shows the conveyer assembly of the system of FIG. 17 with components removed to show a conveyor apparatus.

FIG. 21 shows a feed chute of the system of FIG. 17 connected to the conveyor assembly.

FIG. 22 shows a control layout of the system of FIG. 17.

FIG. 23 shows a flowchart illustrating a method of generating product from the system of FIG. 17.

FIG. 24 shows a layout of the system of FIG. 17 and two silos for feeding material to the two feed hoppers.

FIG. 25 shows a layout of the system of FIG. 17 and two silos for feeding material to the two feed hoppers.

### DETAILED DESCRIPTION

In the drawings, reference numeral 10 generally indicates an embodiment of a mobile blending apparatus, in accordance with the invention, for blending particulate material.

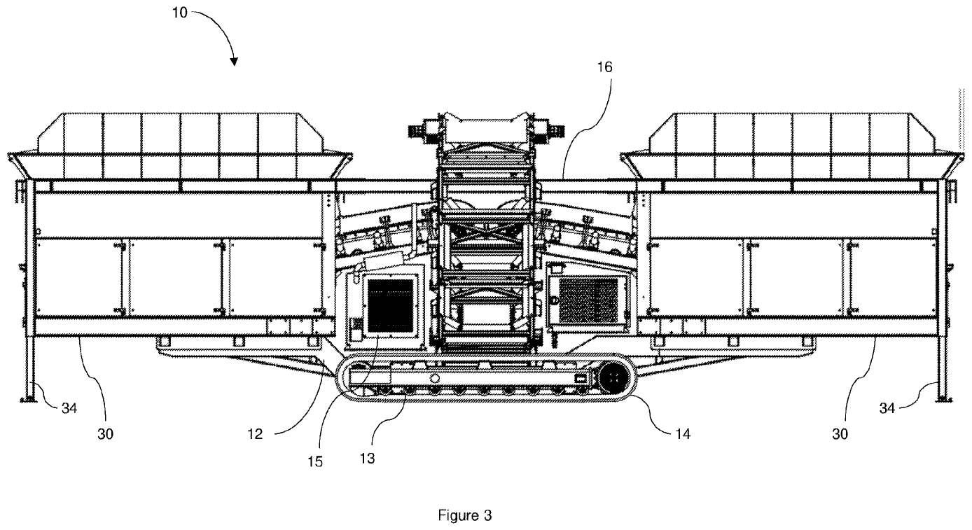

The apparatus 10 includes a chassis 12. A ground engaging drive mechanism 14 is arranged on the chassis 12 and is configured for driving the chassis 12 along the ground. The ground engaging drive mechanism 14 includes a conventional driven track mechanism 13 (FIG. 3) of the type currently used for mobile material handling apparatuses. Thus, the drive mechanism 14 includes a drive unit 15 engaged with the track mechanism 13 in a conventional manner.

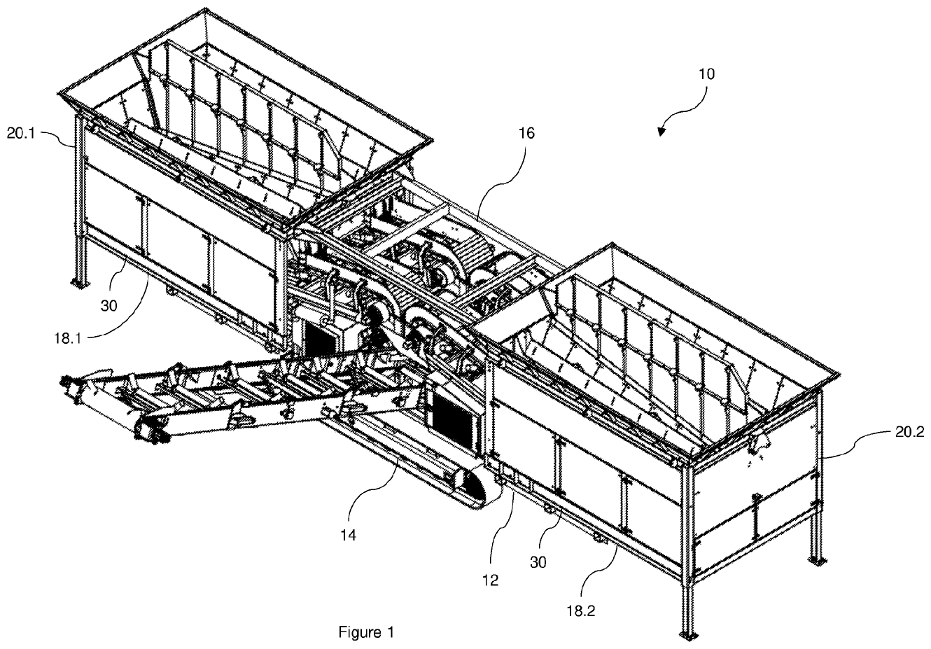

A support structure 16 is mounted on the chassis 12 (FIG. 3). The support structure 16 includes two opposed substructures 18.1, 18.2 (FIG. 1).

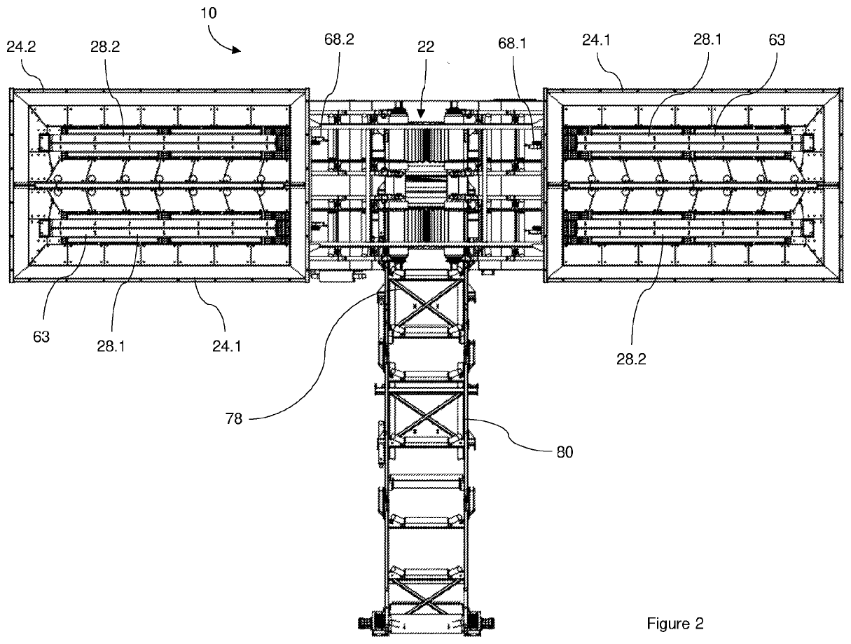

The apparatus 10 includes two hopper assemblies 20.1, 20.2. Each hopper assembly 20.1, 20.2 is mounted on a respective substructure 18.1, 18.2. The substructures 18.1, 18.2 are configured so that a feed zone 22 (FIG. 2) is defined between the hopper assemblies 20.1, 20.2.

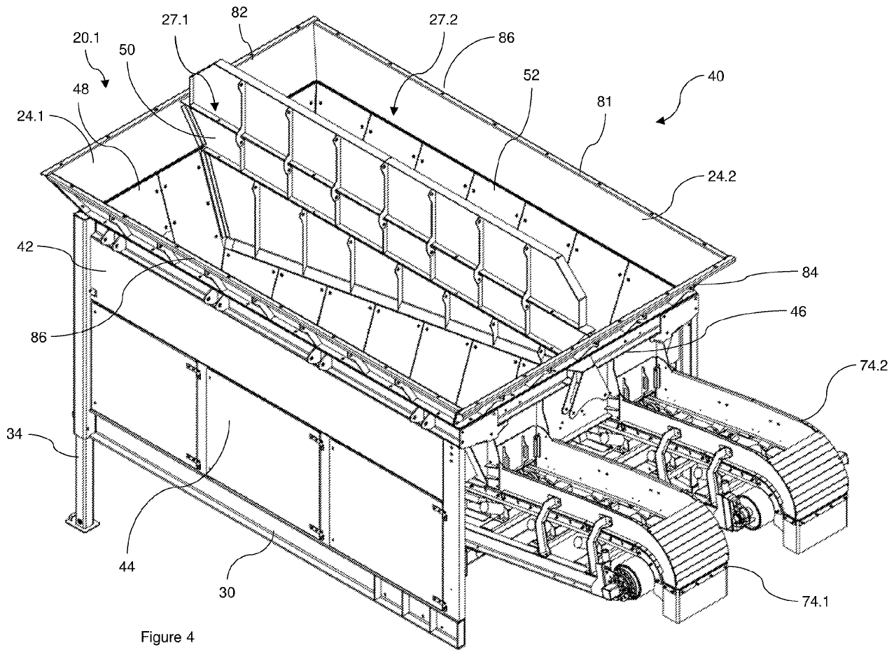

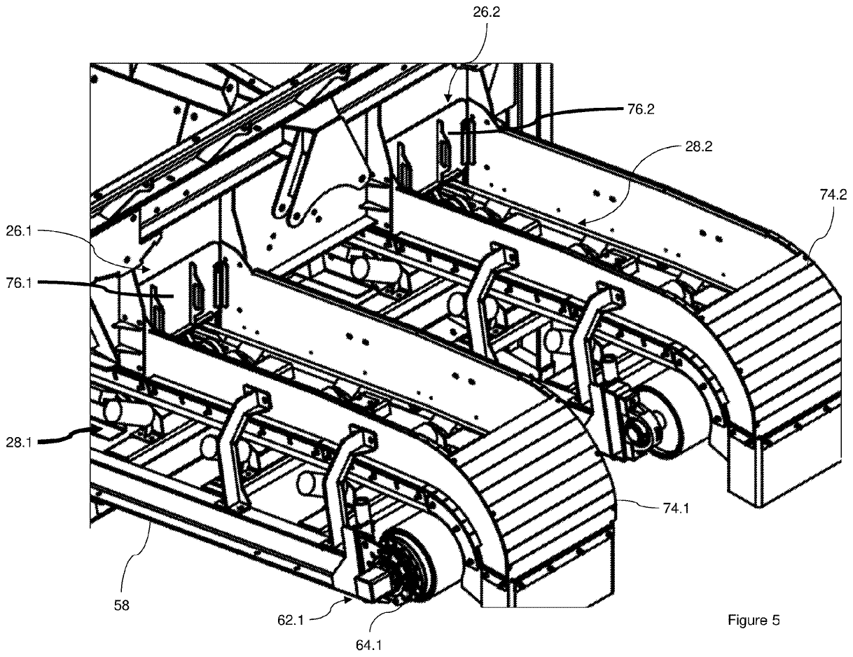

FIG. 4 shows just the hopper assembly 20.1. The hopper assemblies 20.1, 20.2 are substantially the same. Each hopper assembly 20.1, 20.2 includes two receptacles 24.1, 24.2, respectively. Each receptacle 24.1, 24.2 is configured to receive a particulate material to be blended with the particulate material in the other receptacle 24.1, 24.2. Each hopper assembly 20.1, 20.2 includes two feed openings 26.1, 26.2 (FIG. 5) in communication with respective storage volumes 27.1, 27.2 (FIG. 4) defined by the receptacles 24.1, 24.2.

The apparatus 10 includes four conveyor assemblies in the form of two conveyor assemblies 28.1, 28.2 (FIG. 2) mounted in respective receptacles 24.1, 24.2 and extending out of the respective feed openings 26.1, 26.2 to a predetermined extent and into the feed zone 22. Each conveyor assembly 28.1, 28.2 includes a controllable drive mechanism (described below) so that a speed of conveyance of the respective particulate materials from the receptacles 24.1, 24.2 can be controlled independently with a suitable controller (described below).

A continuous weighing mechanism (described below) is operatively engaged with each conveyor assembly 28.1, 28.2, outside of the receptacles 24.1, 24.2, and in the feed zone 22, to measure a feed rate of particulate material from respective receptacles 24.1, 24.2.

The apparatus 10 includes a programmable control mechanism (described below) to control a speed of each conveyor assembly 28.1, 28.2 based on feedback measurements received from the continuous weighing mechanisms to achieve a desired mixture of particulate materials from the receptacles 24.1, 24.2.

The apparatus 10 includes a discharge mechanism (described below) for receiving the mixture and for discharging the mixture at a desired location.

Each substructure 18.1, 18.2 includes a rectangular frame 30. An inner end of the frame 30 is supported on the chassis 12. Two adjustable legs 34 are mounted on an outer end of the frame 30. The adjustable legs 34 are adjustable in length to accommodate the terrain.

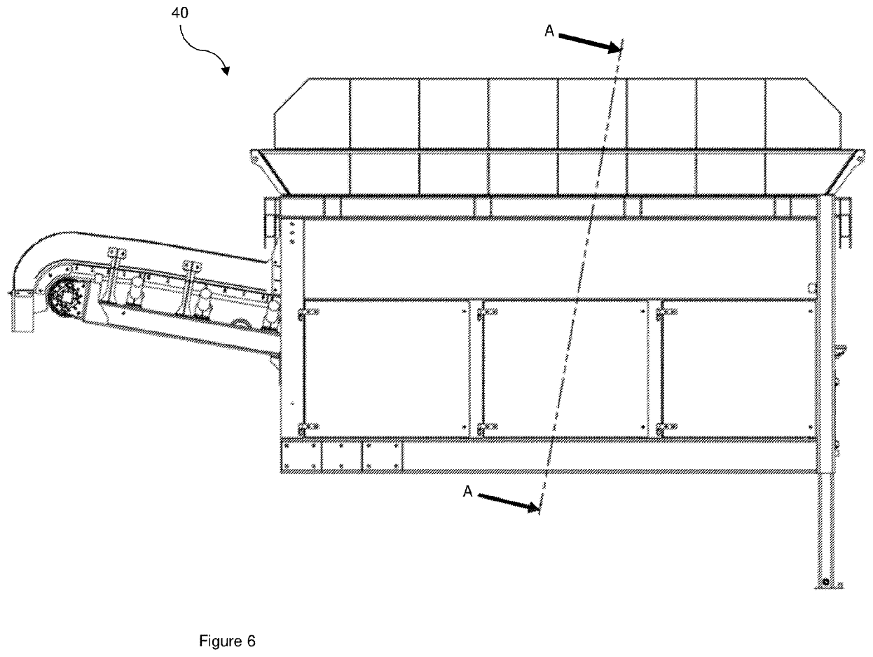

In FIGS. 4 to 10, reference numeral 40 generally indicates an apparatus, which can be part of the apparatus 10, including one of the substructures 18.1 with the hopper assembly 20.1 and two of the conveyor assemblies 28. It is to be appreciated that the apparatus 40 is itself a blending apparatus and is not necessarily dependent on the remaining components of the apparatus 10 to operate. However, it can be mounted on the chassis 12 to be mobile, as with the apparatus 10.

The apparatus 40 is capable of blending two particulate materials stored in the respective receptacles 24.1, 24.2. For the purposes of the following description and for ease of explanation, reference is made to the apparatus 40. It will readily be appreciated that a full understanding of the substructure 18.2 with the hopper assembly 20.2 can be achieved through the description of the apparatus 40. It is envisaged that the apparatus 40 may be an embodiment of one aspect of the invention.

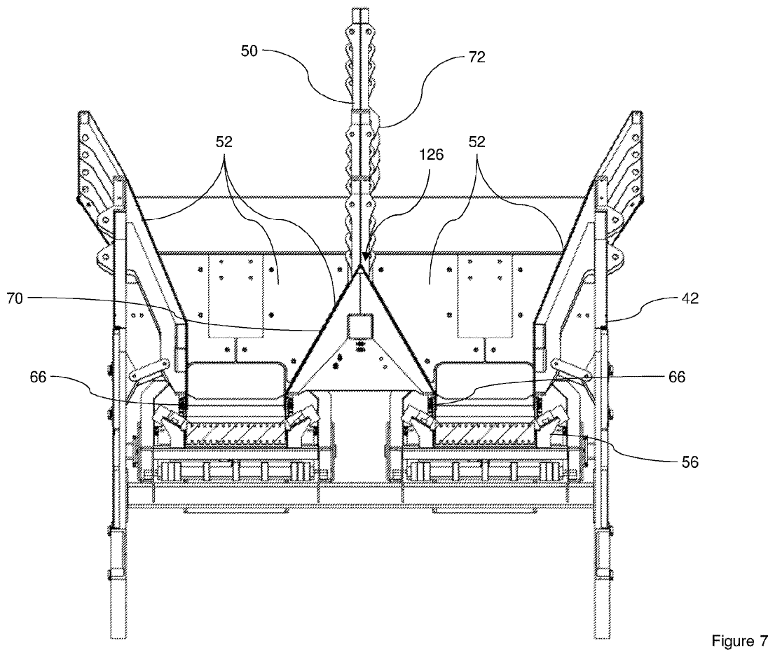

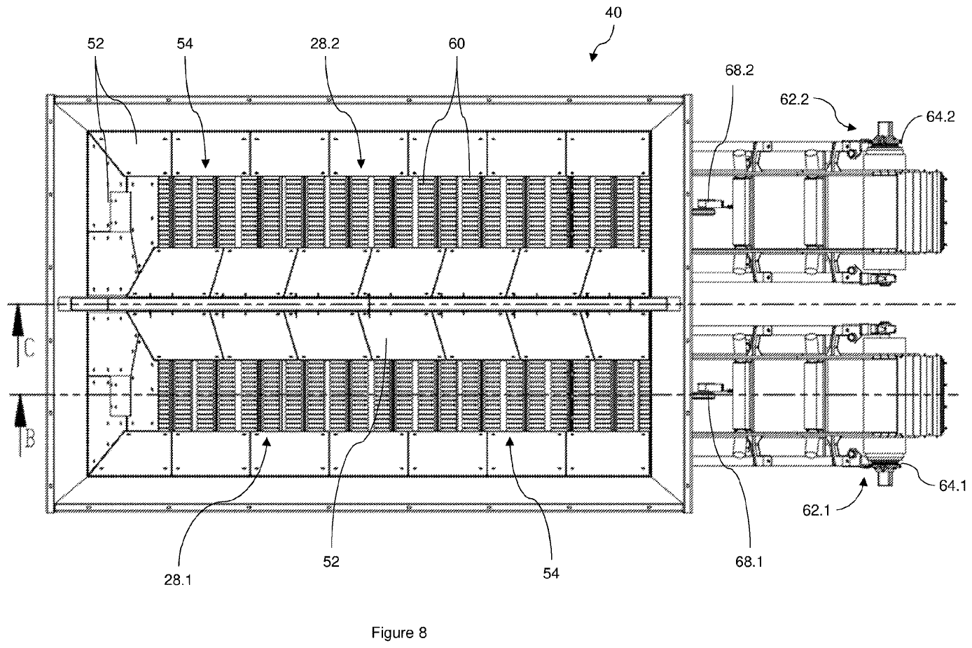

The hopper assembly 20.1 includes a hopper 42 (FIG. 4) that is mounted on the rectangular frame 30. The hopper 42 has opposed side walls 44, a front wall 46 terminating the feed zone 22, an opposed rear wall 48, and a dividing wall 50 extending between the front and rear walls 46, 48. Each of the rear wall 48, the side walls 44, and the dividing wall 50 include inwardly and downwardly sloping sub-walls 52 (FIG. 7) that together define a rectangular floor opening 54 (FIG. 8). Each opening 54 is closed by one of the conveyor assemblies 28.1, 28.2 so that material in the receptacles 24.1, 24.2 is guided onto the respective conveyor assemblies 28.

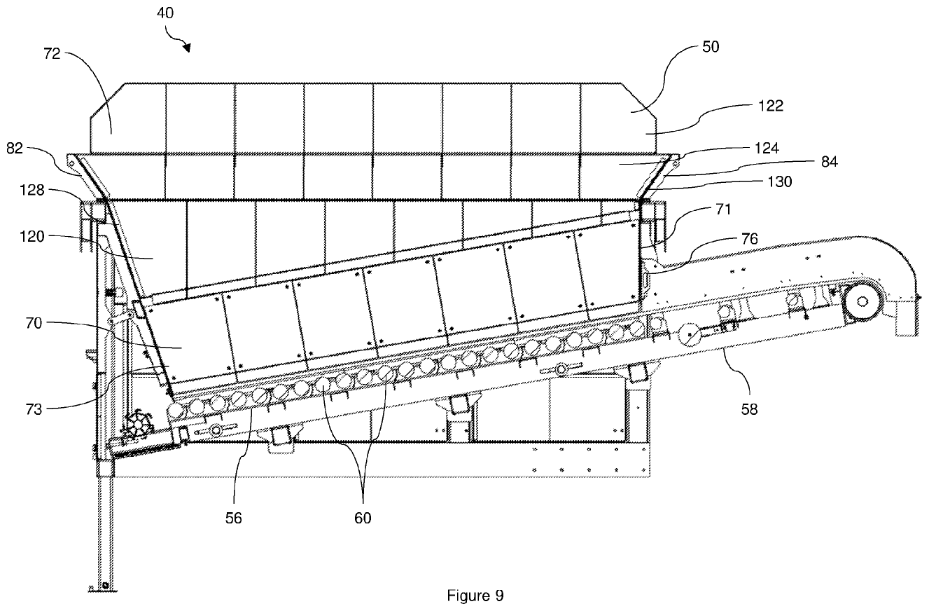

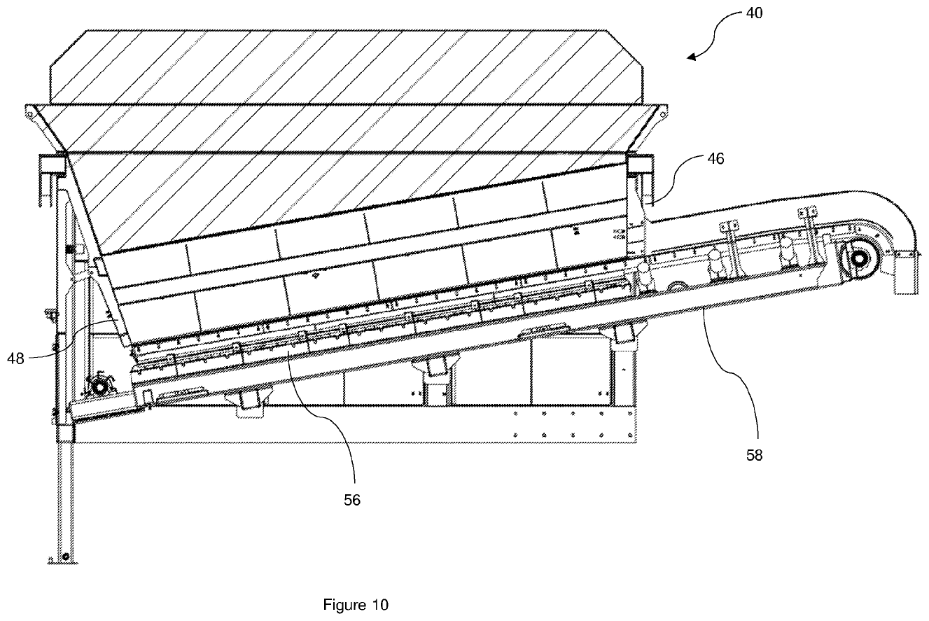

The conveyor assemblies 28.1, 28.2 each include a belt carrier 56 (FIG. 10). The belt carriers 56 extend from the rear wall 48 and out through the feed openings 26.1, 26.2, respectively. The belt carriers 56 are mounted on conveyor support structures 58 that extend upwardly from the rear wall 48 and out past the front wall 46, into the feed zone 22. Each conveyor assembly 28.1, 28.2 includes a series of rollers 60 (FIG. 9) mounted on the belt carrier 56.

Belt drive mechanisms 62.1, 62.2 (FIG. 8) are mounted on the conveyor support structure 58. Each conveyor assembly 28.1, 28.2 includes a conveyor belt 63 (FIG. 2) that extends around the rollers 60 and the belt drive mechanism 62.1, 62.2.

Operation of the belt drive mechanisms 62.1, 62.2 results in the conveyor belt 63 rotating about the carrier 56 and over the rollers 60.

The belt drive mechanisms 62.1, 62.2 include controllable drive motors 64.1, 64.2 so that a speed of each conveyor belt 63 can be controlled with a suitable controller (described below).

The carriers 56 and the conveyor belts 63 are configured so that the conveyor belts 63 effectively close the openings 54. Opposed sealing assemblies 66 (FIG. 7) are interposed between respective sides of the belts 63 and the sub-walls 52 to inhibit the egress of particulate material from the receptacles 24.1, 24.2, past sides of the belts 63.

The continuous weighing mechanism is in the form of belt scale or belt weigh mechanisms 68.1, 68.2 (FIG. 8) mounted on respective carriers 56 and operatively engageable with the belts 63. Thus, the belt weigh mechanisms 68 are capable of continuously measuring the rate of feed of the particulate material from each receptacle 24.1, 24.2.

The inwardly and downwardly sloping sub-walls 52 of the dividing wall 50 are part of a substructure 70 (FIGS. 7, 9) that is fixed to the carriers 56 of the two conveyor assemblies 28. The substructure 70 is configured so that a lower edge of each sub wall 52 is fixed to a respective carrier 56 via the sealing assemblies 66. The sub-walls 52 of the dividing wall 50 converge and connect at their respective upper edges. The dividing wall 50 includes a dividing wall assembly 72 that is removably arranged on the substructure 70 such that the wall assembly 72 partitions the hopper 42 to form the two receptacles 24.1, 24.2. It follows that removal of the dividing wall assembly 72 provides the hopper 42 with a single receptacle. This is convenient where only one form of particulate material is required to be fed from the hopper 42.

The dividing wall assembly 72 is configured to be dropped into the hopper 42 with suitable lifting equipment and located with respect to the substructure 70.

Discharge mechanisms, such as chute assemblies 74.1, 74.2 (FIG. 4), are mounted on the carriers 56 outside of the hopper 42 and are shaped to guide the particulate material downwardly off the conveyor assemblies 28.1, 28.2, respectively.

A flow control gate mechanism is mounted on each receptacle 24.1, 24.2, at or near the feed opening 26.1, 26.2, of the receptacle 24.1, 24.2. The flow control gate mechanism is in the form of feed gates 76.1, 76.2 that are operatively arranged with respect to each of the feed openings 26.1, 26.2, respectively (FIG. 5). The feed gates 76.1, 76.2 are mounted on the front wall 46 and are displaceable between a closed position in which the associated feed opening 26.1, 26.2 is substantially closed and an open position in which the feed opening 26.1, 26.2 is fully open. The feed gates 76.1, 76.2 are adjustable between the closed and open positions so that coarse adjustment of the feed rate of the particulate material from the receptacles 24.1, 24.2 can be achieved. In particular, the feed gates 76.1, 76.2 can be slidably adjustable between the closed and open positions.

A discharge mechanism 78 (FIG. 2) is operatively positioned with respect to the feed zone 22 for receiving particulate material from the conveyor assemblies 28.1, 28.2 such that those materials are mixed or blended. The discharge mechanism 78 includes a discharge conveyor assembly 80 that is configured for conveying the blended particulate material away from the apparatus 10 to be discharged at a desired location.

The hopper 42 includes a flared mouth assembly 81 arranged on upper edges of the walls 44, 46, 48 (FIG. 4). The flared mouth assembly 81 includes a rear section 82, a front section 84, and opposed side sections 86 arranged on respective upper edges of the walls 44, 46, 48.

As can be seen in FIG. 9, the substructure 70 has front and rear ends 71, 73 that correspond with a slope of the front wall 46 and a slope of the sub-walls 52 of the rear wall 48. The upper and lower edges of the substructure 70 are generally parallel. Thus, the upper edge of the substructure 70 slopes upwardly from the rear wall 48 to the front wall 46. A lower edge of the dividing wall assembly 72 nests on the upper edge of the substructure 70.

The dividing wall assembly 72 includes a lower portion 120, an upper portion 122, and an intermediate portion 124 interposed between the upper and lower portions 120, 122 (FIG. 9). A nesting formation 126 (FIG. 7) is arranged on the lower edge of the lower portion 120 to engage with the upper edge of the substructure 70.

The lower portion 120 has an upper end in general alignment with upper sides of the front and rear walls 46, 48. The intermediate portion 124 has an upper end in general alignment with upper sides of the front and rear sections 84, 82 of the mouth assembly 81. The upper portion 122 extends above the mouth assembly 81 to inhibit cross-contamination of the particulate material when charging the receptacles 24.

A rear locating formation 128 is arranged on both the sub-wall 52 of the rear wall 48 and the rear section 82 of the mouth assembly 81. The rear locating formation 128 and the corresponding ends of the lower and intermediate portions 120, 124 of the dividing wall assembly 72 are configured so that the lower and intermediate portions 120, 124 of the dividing wall assembly 72 can be brought into nesting engagement with the rear wall 48 and rear section 82, respectively. The rear locating formation 128 may be in the form of a channel member that defines a channel in which rear sides of the lower and intermediate portions 120, 124 can be received when the dividing wall assembly 72 is lowered into position. Likewise, a front locating formation 130 is arranged on both the front wall 46 and the front section 84 of the mouth assembly 81. The front locating formation 130 and the corresponding ends of the lower and intermediate portions 120, 124 of the dividing wall assembly 72 are configured so that the lower and intermediate portions 120, 124 can be brought into nesting engagement with the front wall 46 and the front section 84. The front locating formation 130 may be in the form of a channel member that defines a channel in which front sides of the lower and intermediate portions 120, 124 can be received when the dividing wall assembly 72 is lowered into position.

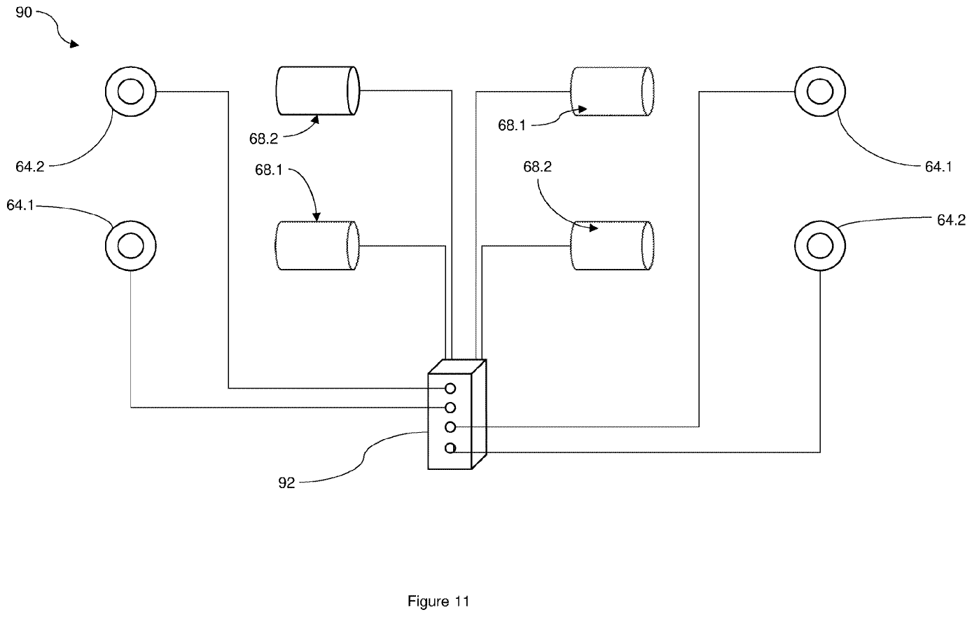

As described above, the conveyor belts 63 are driven by the controllable drive motors 64.1, 64.2. The controllable drive motors 64 are schematically shown in FIG. 11. In FIG. 11, reference 90 generally indicates a control layout of the apparatus 10.

The apparatus 10 includes a programmable control mechanism in the form of a controller 92, for example, a programmed logic controller (PLC). Other forms of controller 92 are also envisaged. The controller 92 is configured for wired or wireless connection to a data processing apparatus, such as a mobile phone, tablet, notebook, or PC, so that controller can programmed, and the operation of the various apparatuses connected to the controller can be monitored.

The controller 92 is connected to each of the four belt weigh mechanisms 68.1, 68.2 and to each of the controllable drive motors 64.1, 64.2. The controller 92 is programmed to control a speed of the drive motors 64.1, 64.2, independently of each other, depending on the required proportions of the desired blend of particulate material sourced from the receptacles 24.1, 24.2. Feedback control of the drive motors 64.1, 64.2 is achieved by processing signals received from the belt weigh mechanisms 68.1, 68.2. For example, a required feed rate from each of the receptacles 24.1, 24.2 can be ascertained before operation of the apparatus 10. Then, during operation, a drive motor 64.1, 64.2 can be speeded up if an associated feed rate needs to be increased to achieve the previously ascertained required feed rate, or slowed down if that feed rate is exceeded.

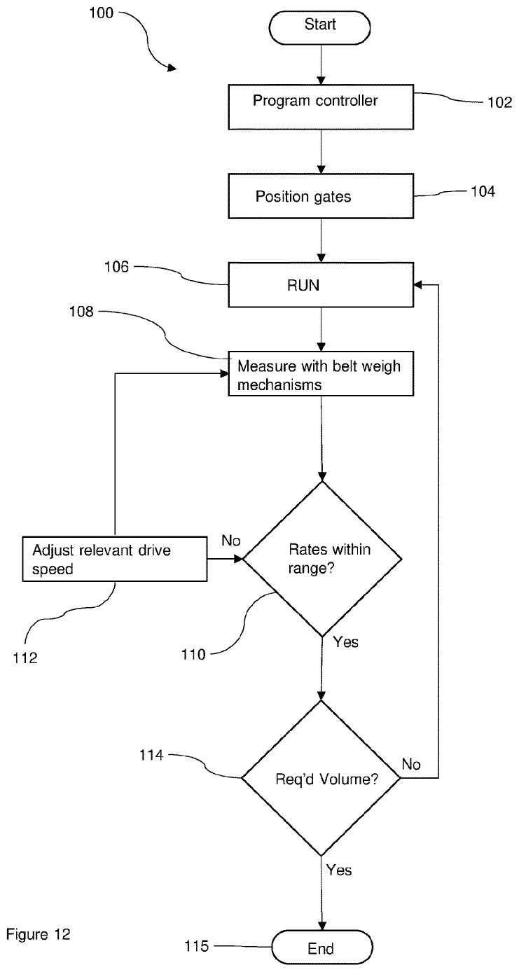

In FIG. 12, reference numeral 100 generally indicates a flowchart illustrating an example of a method, in accordance with the invention, for operating the apparatus 10.

In a first step 102, the controller 92 is programmed with data representing a required feed rate of particulate material from each of the receptacles 24.1, 24.2 to achieve a desired discharged blend.

In a second step 104, the gates 76 are positioned to achieve an initial coarse volumetric flow adjustment from each of the receptacles 24.1, 24.2.

In a third step 106, the drive motors 64 are actuated so that the particulate material can be fed into the feed zone 22.

At 108, the belt weigh mechanisms 68.1, 68.2 measure a feed rate by mass of the particulate material being fed from each of the receptacles 24.1, 24.2. The controller 92 receives the signals from the belt weigh mechanisms 68.1, 68.2 and queries, at 110, whether the feed rates are within a predetermined range to achieve the desired blend. If the query generates “no”, the speed of the relevant drive motor 64 is adjusted at 112. If the query generates a “yes”, the controller 92 queries, at 114, whether a required mass of blend has been fed from the receptacles 24.1, 24.2. If that query generates a “yes”, the controller 92 stops operation of the drive motors 64.1, 64.2 at 115. If that query generates a “no” the drive motors 64.1, 64.2 continue to run.

The hoppers 42 can be dimensioned so that each receptacle 24.1, 24.2 has a volume of between approximately 8 cubic metres and 12 cubic metres, for example, approximately 10 cubic metres. Each hopper 42 can have a length of between approximately 4 metres and 6 metres, for example, approximately 5 metres, and, more particularly, approximately 5.2 metres. Each hopper 42 can have a width of between approximately 2 metres and 4 metres, for example, approximately 3 metres, and, more particularly, approximately 3.3 metres. A distance between the hoppers 42, that is, a length of the feed zone 22, can be between 3.5 metres and 5.5 metres, for example, approximately 4.5 metres. It has been found that this provides sufficient space for the belt weigh mechanisms 68.1, 68.2 to be installed on the conveyor assemblies 28 within the feed zone 22.

The apparatus 10 provides a blending process for blending particulate material in a manner that is significantly more accurate than blending that can be achieved without the use of belt weigh mechanisms. Furthermore, the orientation of the hopper assemblies 20.1, 20.2 allow the four conveyor assemblies 28.1, 28.2 to discharge into the shared feed zone 22. This is achieved by having both the hopper assemblies 20.1, 20.2 mounted on the support structure 16, in that orientation, that is, facing each other, which itself is mounted on the chassis 12. The shared feed zone 22 can accommodate portions of the conveyor assemblies 28.1, 28.2 that are positioned outside of the hopper assemblies 20.1, 20.2, and that are of sufficient length to facilitate the positioning of the belt weigh mechanisms 68.1, 68.2. Thus, all the belt weigh mechanisms 68.1, 68.2 are in the shared feed zone 22. This is advantageous because belt weigh mechanisms 68.1, 68.2 require a certain distance of free belt before and after the mechanisms to obtain an accurate reading. Such mechanisms would not work under the hoppers 42. The resultant configuration is compact, which facilitated mobility of the apparatus 10.

The use of the controller 92 to control a speed of each conveyor assembly 28.1, 28.2 based on measurements received from the weighing mechanisms 68.1, 68.2 can facilitate obtaining a required batch size, a percentage of product from each receptacle 24.1, 24.2, and required tonnes per hour. Furthermore, the controller 92 can be used to control the variable speed of each conveyor assembly 28.1, 28.2 to obtain a desired mix of product from the feed zone 22. Thus, the apparatus 10 provides a means for ameliorating operator error and facilitates the production of accurate and consistent blends or mixtures.

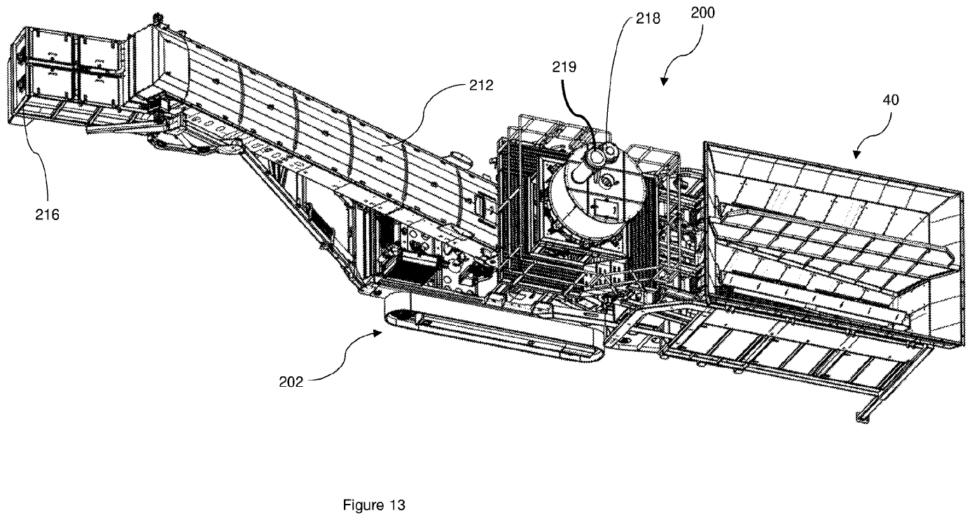

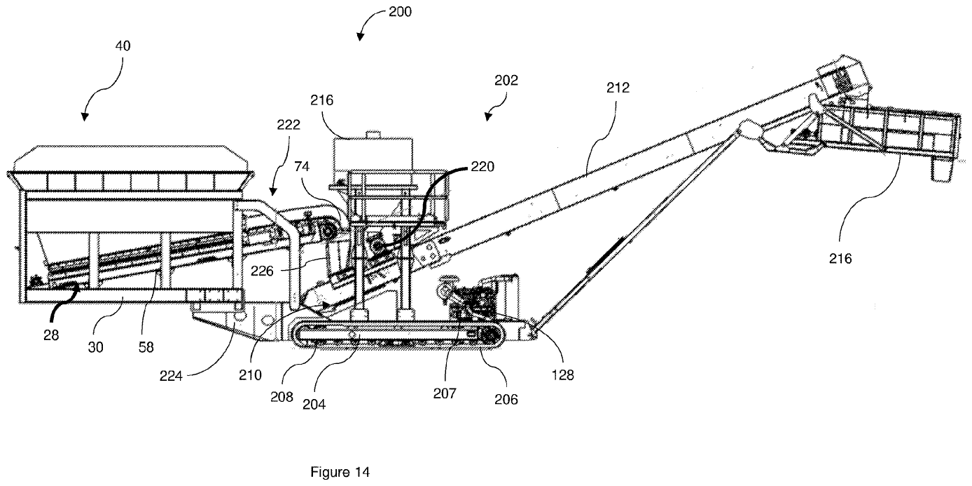

In FIGS. 13 and 14, reference numeral 200 generally indicates a system for blending and mixing materials. The system 200 includes the apparatus 40 in combination with a mobile mixing system 202. With reference to the preceding drawings, like reference numerals refer to like parts, unless otherwise specified. The use of common reference numerals is for convenience and is not intended to limit the scope of the preceding summary or the appended claims.

The system 200 includes a chassis 204 with a driven track assembly 206 mounted on the chassis 204 to drive the chassis 204 over the ground. A drive unit and associated equipment 207 is mounted on the chassis 204 to drive the track assembly 206 and various hydraulic machinery 208 for use with the system 200.

The system 200 includes a support structure 210 mounted on the chassis 204. A conveyor assembly 212 is mounted on the support structure 210 to convey product to a mixing apparatus 216 mounted on a discharge end of the conveyor assembly 212. The mixing apparatus 216 can be a pugmill assembly of the type used to mix particulate material and water to generate a settable product, such as concrete.

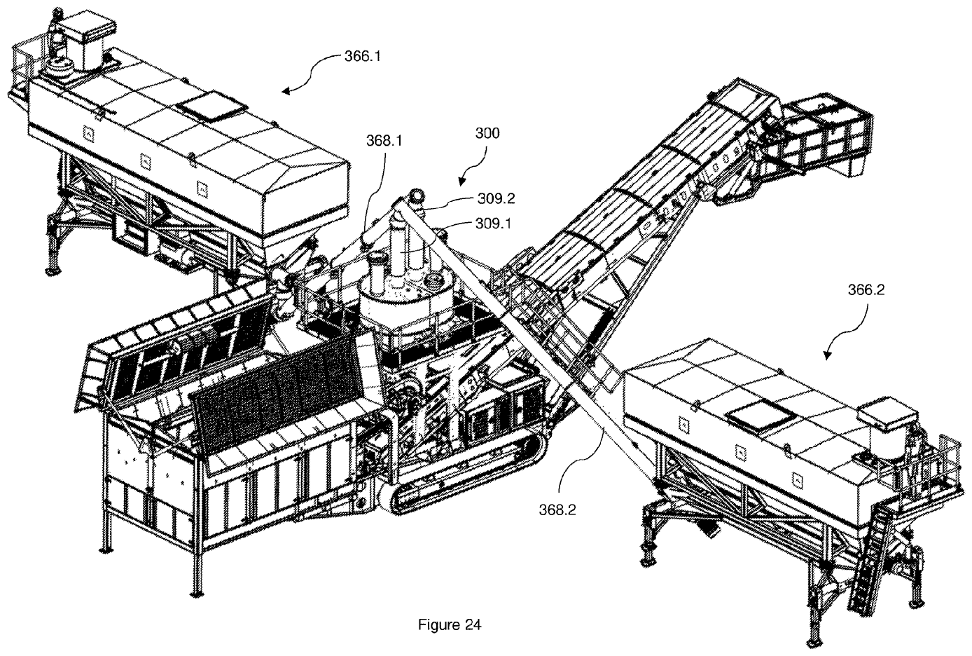

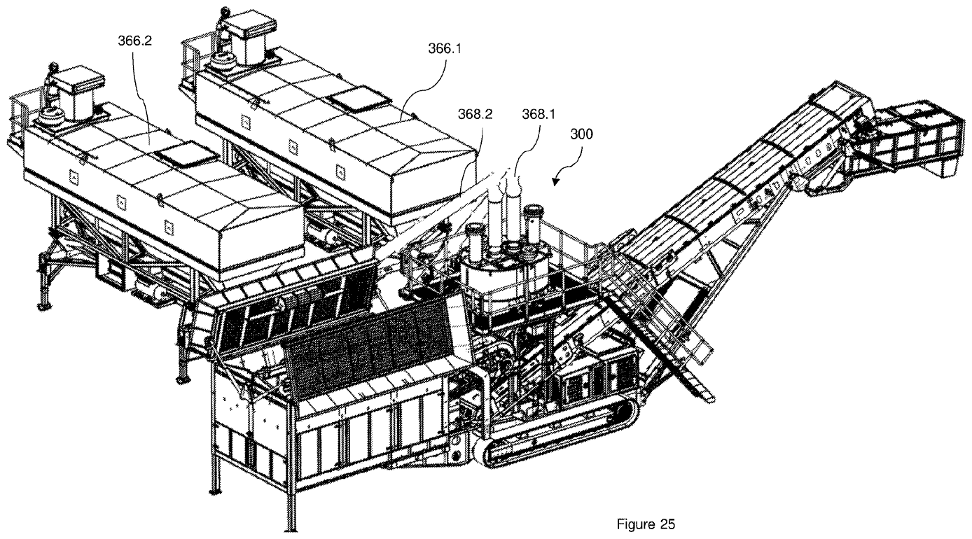

The mixing system 202 includes a vessel in the form of a hopper 218 that is positioned above the conveyer assembly 212 to feed material onto the conveyer assembly 212 for conveyance to the mixing apparatus 216. This material can be in the form of cement, or some other particulate material or powder, depending on the required product from the system 200. The hopper 218 includes an inlet 219 so that the hopper 218 can be charged. For example, the hopper 218 can be charged with powder from a silo, as described with reference to FIGS. 24 and 25, The system 200 includes a valve assembly, for example, a rotary valve assembly 220 that is interposed between an outlet of the hopper 218 and the conveyor assembly 212 to control the feed of material from the hopper 218 onto the conveyor assembly 212.

The support structure 210 includes a substructure 222. The substructure 222 includes an extension 224 that projects rearwardly from the chassis 204. The rectangular frame 30 of the apparatus 40 is mounted on the extension 224. The apparatus 40 is positioned so that the chute assembly 74 is arranged above the conveyor assembly 212, upstream of the valve assembly 220, to feed material from the apparatus 40 onto the conveyor assembly 212. To that end, the system 200 includes a discharge mechanism, for example, one or two feed chutes 226, that interconnect the chute assemblies 74 and the conveyor assembly 212.

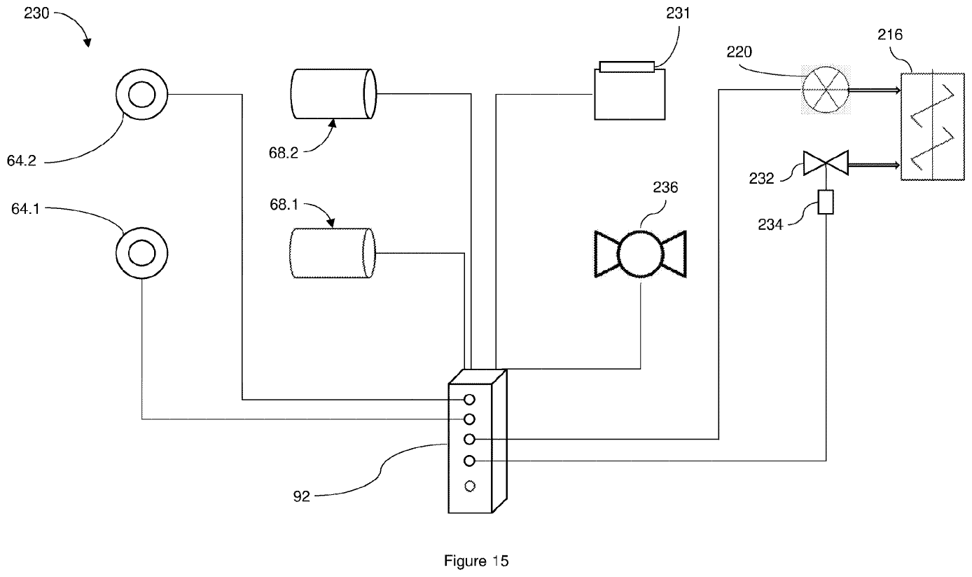

In FIG. 15, reference numeral 230 generally indicates a control layout for the system 200. With reference to the preceding drawings, like reference numerals refer to like parts, unless otherwise specified. The use of common reference numerals is for convenience only and is not intended to limit the scope of the preceding summary and appended claims.

The rotary valve assembly 220 is controllable with the controller 92. Conventionally, load cells 231 are arranged on the hopper 218 to measure the rate of change of the mass of the material in the hopper 218, which provides a feed rate of material from the hopper 218. The load cells 231 are connected to the controller 92 to provide data representing the feed rate of material from the hopper 218. The mixing system 202 also includes, conventionally, a water supply, via a valve 232, to the mixing apparatus 216. The mixing apparatus 216 can be a pugmill. More broadly, the mixing apparatus 216 can be in the form of a paddle mixer, or any other mixer that is required to mix materials from the apparatus 40, material from the hopper 38, and water, depending on requirements. Pugmills usually incorporate a valve-controlled water supply so that water can be mixed with dry material fed into the pugmill. It follows that the material in the hopper 218 can be a dry cementitious powder or other settable material that is fed to the mixing apparatus 216 via the valve assembly 220 and the conveyor assembly 212. Thus, material from the apparatus 40 and material from the hopper 218 can be fed together to the mixing apparatus 216.

A valve actuator 234 is connected to the valve 232. The actuator 234 is operatively connected to the controller 92, so that the valve 232 can be opened or closed with the controller 92. A flowmeter 230 is arranged, conventionally, with respect to the water supply to measure the rate of flow of water into the mixing apparatus 216.

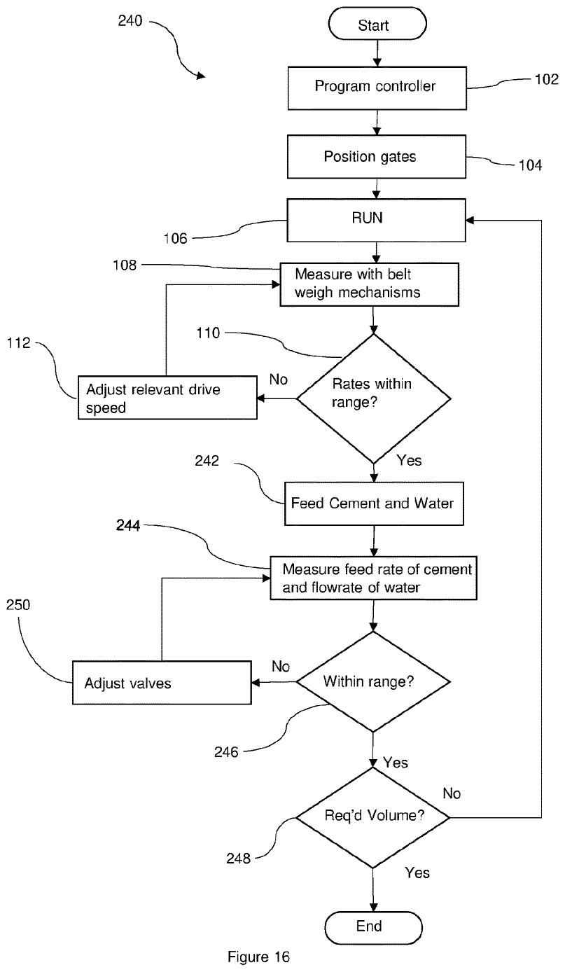

In FIG. 16, reference numeral 240 generally indicates a flowchart illustrating an example of a method, in accordance with the invention, for operating the system 200. With reference to the preceding drawings, like reference numerals refer to like steps, unless otherwise specified. Use of common reference numerals is for convenience and is not intended to limit the scope of the preceding summary or the appended claims.

In this example, the controller 92 is programmed at 102 to generate a desired feed rate of respective materials from each of the receptacles 24.1, 24.2 to achieve a desired discharged blend for feeding into the conveyor assembly 212. The controller 92 is also programmed to feed a desired amount of material from the hopper 218 in proportion to the materials from the receptacles 24.1, 24.2, onto the conveyor assembly 212 to be conveyed together to the mixing apparatus 216. In addition, the controller 92 is programmed to add water to the mixing apparatus 216, to mix with the material discharged from the receptacles 24.1, 24.2, and the hopper 218 in the mixing apparatus 216.

If the feed rates from the conveyor assemblies 28 of the apparatus 40 are within a desired range, the controller 92 acts to open the rotary valve assembly 220 and the valve 232, via the actuator 234, at 242, to feed material from the hopper 218 onto the conveyor assembly 212 and water into the mixing apparatus 216 so that material from the conveyor assemblies 28, material from the hopper 218, and water can be mixed in the mixing apparatus 216, in predetermined proportions, and discharged. It will be appreciated that control of the speed of the conveyor assemblies 28.1, 28.2, and operation of the valve assembly 220 and valve 232 need not take place sequentially. Rather, these components can be controlled together to achieve feed of a desired mixture into the mixing apparatus 216.

The load cells 231 and the flowmeter 230 provide signals to the controller 92 so that the rate of feed of the cement and water into the mixing apparatus 216 can be measured at 244. The controller 92 queries, at 246, whether the rates of feed of the cement and water are within an acceptable range. If not, the controller 92 adjusts the rotary valve assembly 220 and the valve 232, via the actuator 234 at 250. If the rates are within an acceptable range, the controller queries, at 248, whether an overall required mass of product has been fed from the mixing apparatus 216. It will be appreciated that this value can readily be ascertained from the data provided by the belt weigh mechanisms 68, the load cells 162 and the flowmeter 236. If so, the controller 92 can shut down the drive motors 64 and close the rotary valve mechanism 140 and the valve 164.

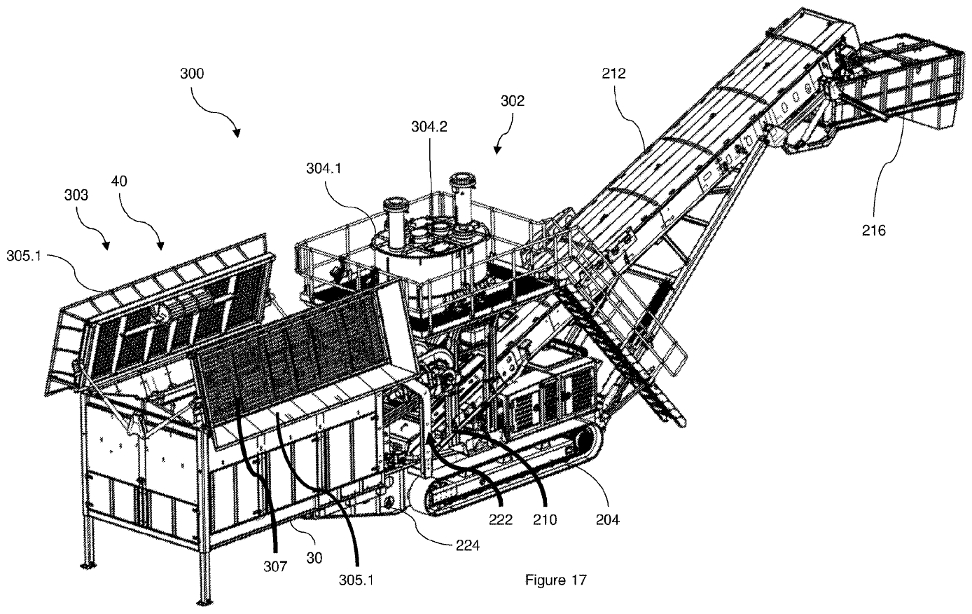

In FIG. 17, reference numeral 300 generally indicates a system for blending materials. The system 300 includes the apparatus 40 in combination with a mobile mixing system 302. With reference to the preceding drawings, like reference numerals refer to like parts, unless otherwise specified. The use of common reference numerals is for convenience and is not intended to limit the scope of the preceding summary or the appended claims.

In this example, the apparatus 40 includes a hydraulically operated gate assembly 303 that has two gates 305.1, 305.2 that can operate to open and close the receptacles 24.1, 24.2. Each gate 305 incorporates a sieve or mesh wall 307 so that, once closed, an initial screening of material fed into the receptacles 24.1, 24.2 can take place.

The mobile mixing system 302 is similar to the system 202, with a primary difference being that the system 302 includes two feed hoppers 304.1, 304.2 positioned above the conveyor assembly 212. Thus, apart from the two feed hoppers 304.1, 304.2, the detail described with reference to the system 302 is applicable to the system 202.

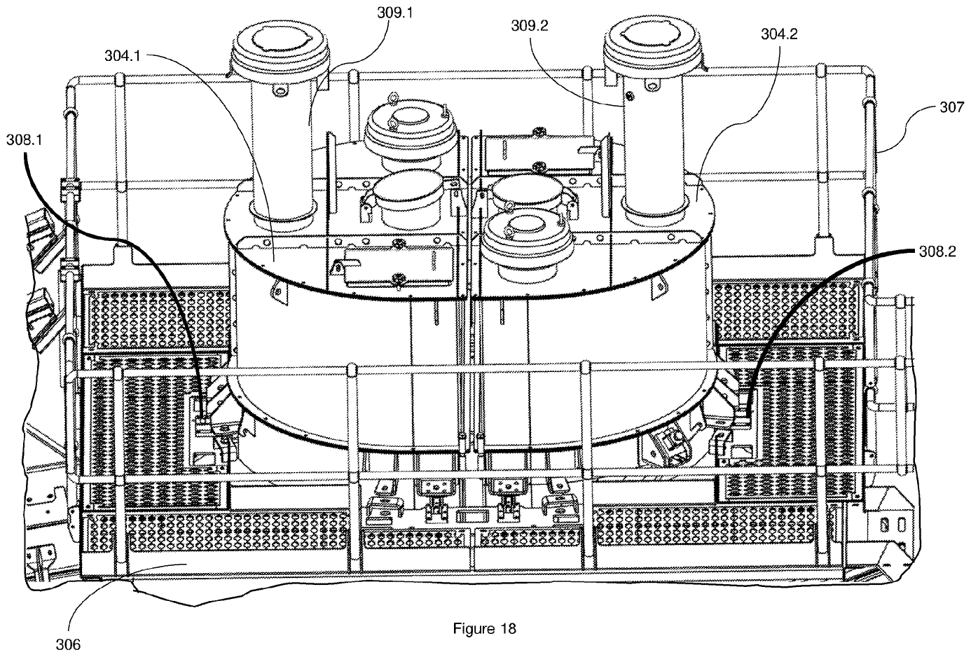

The feed hoppers 304.1, 304.2 are mounted on a support structure 306 that includes a platform assembly 307 for personnel (FIG. 18). Load cells 308.1, 308.2 are interposed between respective feed hoppers 304.1, 304.2, so that a mass of material in the feed hoppers 304.1, 304.2 can be measured dynamically and the associated data communicated to the controller 92. Thus, a feed rate from each of the hoppers 304.1, 304.2 can be measured.

Each of the hoppers 304.1, 304.2 has feed inlets 309.1, 309.2 for connection to a feed conduit from a silo, as set out below.

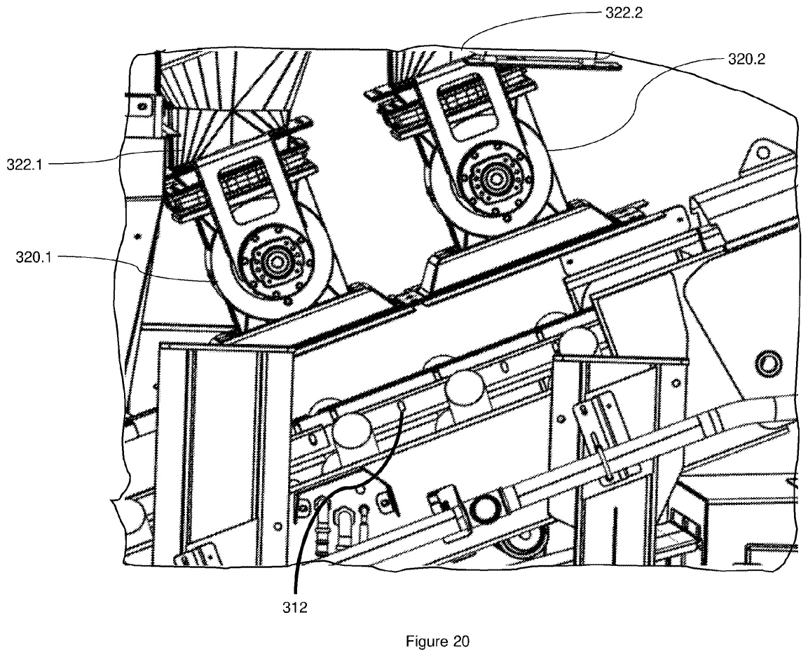

The conveyer assembly 212 includes a cover assembly 310 for covering a conveyor apparatus 312 of the conveyor assembly 212 (FIG. 20). The cover assembly 310 includes a cover plate 314. The chute assemblies 74 are connected to, and in fluid communicate with the feed chute 226, which is connected to the cover plate 314 to feed material from the apparatus 40 through an opening in the cover plate 314, and onto the conveyor apparatus 312.

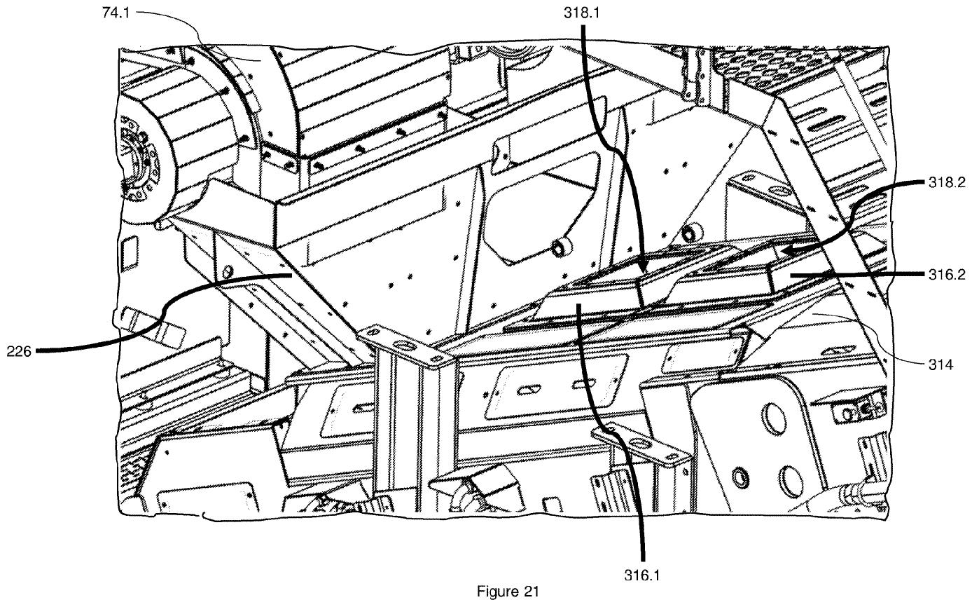

Two mounting assemblies 316.1, 316.2 are mounted on the cover plate 314, upstream of the feed chute 226 (FIG. 21). The mounting assemblies 316.1, 316.2 define inlet openings 318.1, 318.2 that are in fluid communication with corresponding openings in the cover plate 314.

Two rotary valve assemblies 320.1, 320.2 are interposed between respective mounting assemblies 316.1, 316.2 and corresponding outlets 322.1, 322.2 of the hoppers 304.1, 304.2. Thus, operation of the rotary valve assemblies 320.1, 320.2 results in product being discharged from the hoppers 304.1, 304.2 onto the conveyor assembly. The rotary valve assemblies 320.1, 320.2 are configured to be controlled by the controller 92. Thus, the controller 92 can receive data from the load cells 308.1, 308.2 to operate the rotary valve assemblies 320.1, 320.2 in accordance with a desired discharge rate from the hoppers 304.1, 304.2.

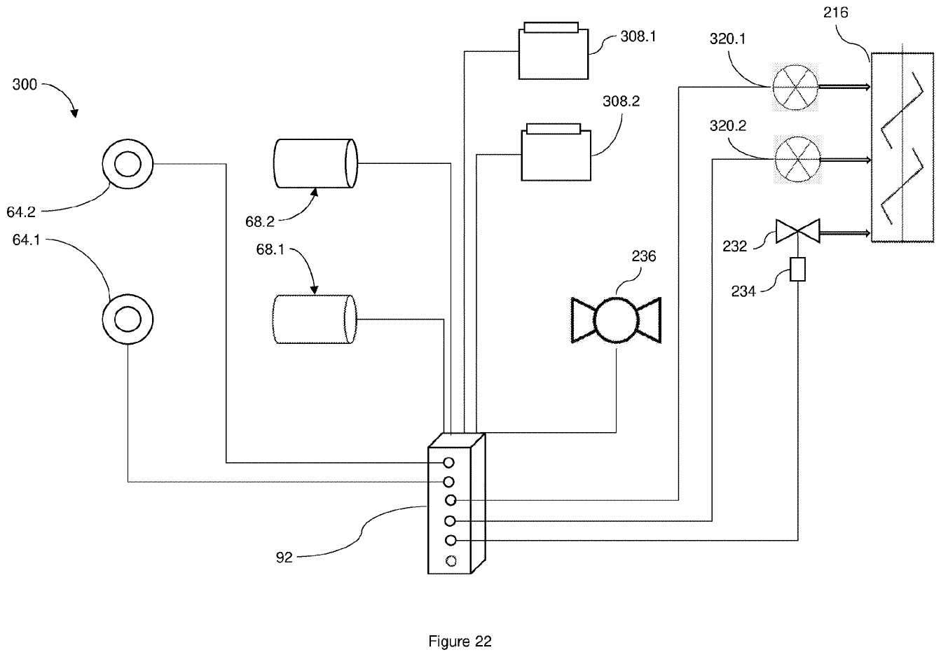

In FIG. 22, reference numeral 330 generally indicates a control layout for the system 300. With reference to the preceding drawings, like reference numerals refer to like parts, unless otherwise specified. The use of common reference numerals is for convenience only and is not intended to limit the scope of the preceding summary and appended claims.

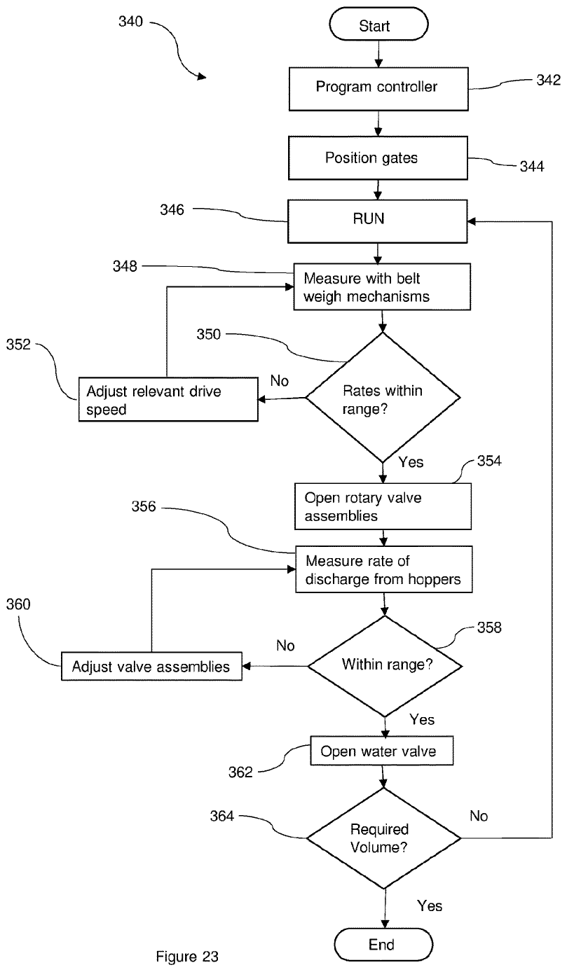

In FIG. 23, reference numeral 340 generally indicates a flowchart illustrating an example of a method, in accordance with the invention, for operating the system 300. With reference to the preceding drawings, like reference numerals refer to like parts, unless otherwise specified. The use of common reference numerals is for convenience only and is not intended to limit the scope of the preceding summary and appended claims.

In this example, the controller 92 is programmed at 342 to generate a desired feed rate of respective materials from each of the receptacles 24.1. 24.2 to achieve a desired discharge blend for feeding onto the conveyor apparatus 312. The controller 92 is also programmed to feed a desired mixture of materials from each of the two hoppers 304.1, 304.2 in proportion to the materials from the receptacles 24.1, 24.2 onto the conveyor apparatus 312 to be conveyed together to the mixing apparatus 216. In addition, the controller 92 is programmed to add water to the mixing apparatus 216, to mix with the material discharged from the receptacles 24.1, 24.2, and the hoppers 304.1, 304.2, in the mixing apparatus 216.

At 344, the gates 76 are positioned to achieve an initial coarse volumetric flow adjustment from each of the receptacles 24.1, 24.2 to achieve a desired discharged blend.

At 346, the drive motors 64.1, 64.2 are actuated so that the particulate material can be fed into the feed zone 22.

At 348, the belt weigh mechanisms 68.1, 68.2 measure a feed rate by mass of the particulate material being fed from each of the receptacles 24.1, 24.2. The controller 92 receives the signals from the belt weigh mechanisms 68.1, 68.2 and queries, at 350, whether the feed rates are within a predetermined range to achieve desired proportions of the materials from the receptacles 24.1, 24.2 to be discharged onto the conveyor apparatus 312. If the query generates “no”, the speed of the relevant drive motor 64.1, 64.2 is adjusted at 352. If the query generates “yes”, the controller 92 acts at 354 to open the rotary valve assemblies 320.1, 320.2 to an appropriate extent relative to each other so that desired relative proportions of the materials from the hoppers 304.1, 304.2 can be discharged onto the conveyor apparatus 312. At 356, the controller 92 measures the rate of discharge from the hoppers 304.1, 304.2, using signals from the load cells 308.1, 308.2. At 358, the controller queries whether the rates of discharge from the hoppers 304.1, 304.2 are within a predetermined range to achieve desired proportions of the material from the hoppers 304.1, 304.2. If the query generates “no”, the valve assemblies 320.1, 320.2 are adjusted, at 360, and the process reverts to step 356. If the query generates “yes”, the controller 92 opens the water valve 232 at 362. At 364, the controller 92 queries whether a required volume of mixture has been discharged from the mixing apparatus 216. If the query returns “no”, the process continues. If the query returns “yes”, the controller 92 shuts down the drive motors 64, closes the valve assemblies 320.1, 320.1, and closes the water valve 232.

It is envisaged that the above steps do not necessarily need to take place in the order described. The order can vary, and some steps can be taken simultaneously, depending on requirements.

The controller 92 is programmed to shut down the various apparatuses if materials are no longer being discharged from either of the receptacles 24.1, 24.2, or the hoppers 304.1, 304.2.

During the programming step 342, data relating to the weight of the product can be written to the controller 92. This can be sum of the raw materials to be carried by the receptacles 304.1, 304.2, the powders to be carried by the hoppers 304.1, 304.2, and the water to be used. This can also include a further liquid that may be fed into the mixing apparatus 216. The data can include proportions of the different constituents. The controller 92 can be configured to shut down the various apparatuses if the measurements received from the belt weigh mechanisms 68, the load cells 308.1, 308.2, and the flowmeter 236 indicate that the required proportions cannot be met.

Thus, the controller 92 is programmed to use signals from the belt weigh mechanisms 68, and the load cells 308.1, 308.2 to adjust the speeds of the conveyor assemblies 28.1, 28.2 and the extent of opening of the valve assemblies 320.1, 320.2 to achieve desired proportions of the materials from the receptacles 24.1, 24.2, and the hoppers 304.1, 304.2 to be fed onto the conveyor apparatus 312.

It will be appreciated that the controller 92 can be programmed in any way to achieve a desired mix of products entering the mixing apparatus 216.

It will be appreciated that the system 200, 300 facilitates use of recycled material together with a material, such as cement or any other desired powder, to provide products that contain required amounts of recycled material. The use of the controller 92 and the belt weigh mechanisms 68 facilitates accurate supply of such recycled materials to the mixing apparatus 216.

The system 300 is particularly useful since it allows four different dry materials to be fed to the mixing apparatus 216, or otherwise discharged, in any proportion.

Furthermore, as set out above, the process of providing the dry materials to the mixing apparatus 216 together with water is fully automated using the controller 92 that receives feedback from the belt weigh mechanisms 68 and the load cells 308.1, 308.2.

In FIGS. 24 and 25, the system 300 is shown with two silos 366.1, 366.2 containing powder for the hoppers 304.1, 304.2. In FIG. 24, the silos 366.1, 366.2 are shown on respective sides of the mixing system 302. In FIG. 25, the silos 366.1, 366.2 are shown on one side of the mixing system 302.

Powder feed conduits 368.1, 368.2 connect the silos 366.1, 366.2 to the inlets 309.1, 309.2, respectively. Each silo 366.1, 366.2 includes an auger to feed powder from the silos 366.1, 366.2 to the hoppers 304.1, 304.2, via the conduits 368.1, 368.2, and the inlets 309.1, 309.2.

The augers can be connected to the controller 92 that is programmed to control operation of the augers. The controller 92 can be programmed to actuate one of the augers when the associated hopper 304.1, 304.2, is empty or at a predetermined low level, such that a desired amount of powder is fed to the associated hopper 304.1, 304.2. The controller 92 can be programmed so that, once the associated hopper 304.1, 304.2 is refilled, the controller recalibrates the required data and resets proportions if necessary.

The appended claims are to be considered as incorporated into the above description.

Throughout this specification, reference to any advantages, promises, objects or the like should not be regarded as cumulative, composite, and/or collective and should be regarded as preferable or desirable rather than stated as a warranty.

Throughout this specification, unless otherwise indicated, “comprise,” “comprises,” and “comprising,” (and variants thereof) or related terms such as “includes” (and variants thereof),” are used inclusively rather than exclusively, so that a stated integer or group of integers may include one or more other non-stated integers or groups of integers.

When any number or range is described herein, unless clearly stated otherwise, that number or range is approximate. Recitation of ranges of values herein are intended to serve as a shorthand method of referring individually to each separate value falling within the range, unless otherwise indicated herein, and each separate value and each separate subrange defined by such separate values is incorporated into the specification as if it were individually recited herein.

Words indicating direction or orientation, such as “front”, “rear”, “back”, etc, are used for convenience. The inventor(s) envisages that various embodiments can be used in a non-operative configuration, such as when presented for sale. Thus, such words are to be regarded as illustrative in nature, and not as restrictive.

Features which are described in the context of separate aspects and embodiments of the invention may be used together and/or be interchangeable. Similarly, features described in the context of a single embodiment may also be provided separately or in any suitable sub-combination.

It is to be understood that the terminology employed above is for the purpose of description and should not be regarded as limiting. The described embodiments are intended to be illustrative of the invention, without limiting the scope thereof. The invention is capable of being practised with various modifications and additions as will readily occur to those skilled in the art.

1. A mobile blending apparatus, which comprises:
a chassis;
a ground-engaging drive mechanism that is arranged on the chassis and is configured for driving the chassis along the ground;
a support structure mounted on the chassis, the support structure including two opposed substructures;
two hopper assemblies, each hopper assembly mounted on a respective substructure, the substructures being configured so that a feed zone is defined between the hopper assemblies, each hopper assembly including:
two receptacles, each receptacle configured to receive a material to be blended with the material in the other receptacle; and
two feed openings in communication with respective storage volumes defined by the receptacles;
four conveyor assemblies mounted in respective receptacles and extending out of the respective feed openings to a predetermined extent and into the feed zone, each conveyor assembly including a controllable drive mechanism so that a speed of conveyance of the respective materials from the receptacles can be controlled with a suitable controller;
a continuous weighing mechanism operatively engaged with each conveyor assembly in the feed zone to measure a feed rate of material from respective receptacles; and
a programmable control mechanism to control a speed of each conveyor assembly based on measurements received from the continuous weighing mechanisms to achieve a desired mixture of materials from the receptacles.

2. The mobile blending apparatus as claimed in claim 1, wherein each substructure includes a rectangular frame with an inner end of the frame supported on the chassis, and two legs that are arranged on an outer end of the frame to support the frame above the substrate.

3. The mobile blending apparatus as claimed in claim 2, wherein each hopper assembly includes a hopper mounted on the rectangular frame, the hopper having opposed side walls, a front wall terminating the feed zone, an opposed rear wall, and a dividing wall extending between the front and rear walls and dividing the hopper into the two receptacles.

4. The mobile blending apparatus as claimed in claim 3, wherein at least part of the dividing wall is removable to provide the hopper with a single receptacle.

5. The mobile blending apparatus as claimed in claim 4, wherein the dividing wall nests with the front and rear walls in an operative position forming the two receptacles.

6. The mobile blending apparatus as claimed in claim 3, wherein each of the front wall, the rear wall, the side walls, and the dividing wall includes inwardly and downwardly sloping sub-walls that together define a rectangular floor opening, the conveyor assembly being configured so that the rectangular floor opening is closed by the conveyor assembly such that material in the receptacles is guided onto the respective conveyor assemblies.

7. The mobile blending apparatus as claimed in claim 1, wherein each conveyer assembly includes a conveyor belt, so that the conveyor belts define floors of the respective receptacles.

8. The mobile blending apparatus as claimed in claim 7, wherein each conveyor assembly includes a belt carrier and rollers arranged on the belt carrier and engaged with the conveyor belt to facilitate the rotation of the conveyor belt about the belt carrier.

9. The mobile blending apparatus as claimed in claim 8, which includes a conveyor support structure, the belt carrier being mounted on the conveyor support structure that extends upwardly from the rear wall and out through the feed opening.

10. The mobile blending apparatus as claimed in claim 9, wherein each controllable drive mechanism is mounted on a respective conveyor support structure and is operatively engaged with the conveyor belt so that a speed of the conveyor belts can be controlled independently.

11. The mobile blending apparatus as claimed in claim 6, wherein the dividing wall includes a substructure, the sub-walls of the dividing wall being part of the substructure, the sub-walls converging at their respective upper edges, the dividing wall further including a dividing wall assembly that is removably arranged on the substructure such that the dividing wall assembly partitions the hopper to form the two receptacles and can be removed to form the single receptacle.

12. The mobile blending apparatus as claimed in claim 11, wherein front and rear locating formations are arranged on the front and rear walls, respectively, of each hopper, the locating formations being configured so that the dividing wall assembly can be lowered into nesting engagement with the front and rear walls to form the two receptacles of each hopper.

13. The mobile blending apparatus as claimed in claim 7, wherein each continuous weighing mechanism is in the form of a belt weighing mechanism that is operatively engaged with the conveyor belt for dynamically weighing the material being conveyed by the conveyor belt.

14. The mobile blending apparatus as claimed in claim 1, wherein the control mechanism includes a controller that is operatively connected to the continuous weighing mechanisms and the drive mechanisms to adjust the speed of the conveyance of the respective materials from the receptacles to maintain or achieve a desired mixture of the materials.

15. The mobile blending apparatus as claimed in claim 1, wherein a flow control gate mechanism is mounted on each receptacle at or near the feed opening of the receptacle, and is operable to control, to some extent, a volumetric feed rate of material carried by the conveyor assembly into the feed zone.

16. A method of blending material with the mobile blending apparatus as claimed in claim 1, the method comprising the steps of:
charging the respective receptacles with materials to be blended;
driving the respective conveyor assemblies to feed material from the receptacles to the a discharge mechanism; and
controlling the speed of each conveyor assembly with the control mechanism to achieve the desired mixture of materials from the receptacles.

17. A mobile blending system which comprises:
a chassis;
a ground-engaging drive mechanism that is arranged on the chassis and is configured to drive the chassis along the ground;
a support structure mounted on the chassis;
a hopper assembly that is mounted on the support structure, the hopper assembly including:
two receptacles, each receptacle configured to receive a material that is to be blended with the material in the other receptacle; and
two feed openings in communication with respective storage volumes defined by the receptacles;
two conveyor assemblies mounted in respective receptacles and extending out of the respective feed openings to a predetermined extent and into a feed zone, each conveyor assembly including a controllable drive mechanism so that a speed of conveyance of the respective materials from the receptacles can be controlled with a suitable controller;
a continuous weighing mechanism operatively engaged with each conveyor assembly to measure a feed rate of material from respective receptacles; and
a mixing system mounted on the support structure, the mixing system comprising:
a conveyor assembly that is mounted on the support structure and extends from the support structure;
at least one vessel mounted on the support structure, above the conveyer assembly of the mixing system; and
a valve assembly interposed between the, or each vessel and the conveyor assembly of the mixing system to control the supply of material from the, or each vessel to the conveyor assembly of the mixing system, the valve assembly being operatively connected to the programmable control mechanism for controlling operation of the valve assembly.

18. The mobile blending system as claimed in claim 17, which includes a mixing apparatus mounted on a discharge end of the conveyor assembly for mixing product from the hopper assemblies and the, or each vessel.

19. A method of blending material with the mobile blending system as claimed in claim 17, the method comprising the steps of:
charging the respective receptacles with materials to be blended;
charging the, or each vessel with material to be blended with the material in the receptacles;
driving the conveyor assemblies that extend from the receptacles to feed material from the receptacles to the conveyor assembly of the mixing system; and
controlling the speed of each conveyor assembly and operation of the, or each valve assembly to achieve a desired mixture of materials from the mixing system.

20. The mobile blending apparatus as claimed in claim 1, which includes a discharge mechanism for receiving the mixture and discharging the mixture at a desired location.
